(19) United States
(12) Patent Application Publication
(10) Pub. No.: US 2023/0184032 A1
(43) Pub. Date: Jun. 15, 2023

(54) Wind Spring Coiling Apparatus with Wind Spring Built in Upper Beam

(71) Applicant: Ningbo Zhenfei Decorated Curtain Co., Ltd., Yuyao (CN)

(72) Inventor: Jiefei Lu, Yuyao (CN)

(21) Appl. No.: 18/063,076

(22) Filed: Dec. 7, 2022

(30) Foreign Application Priority Data
Dec. 9, 2021 (CN) 202123083043.5
Mar. 17, 2022 (CN) 202220582065.1
Aug. 22, 2022 (WO) PCT/CN2022/113812

(51) Int. Cl. E06B 9/56; E06B 9/44

(52) U.S. Cl. CPC E06B 9/56; E06B 9/44

(57) ABSTRACT

Disclosed in the disclosure is a wind spring coiling apparatus with a wind spring built in an upper beam, including an upper beam and a bracket. A reel is mounted on the bracket. The coiling apparatus includes a wind spring, fixed discs and a coiling disc, the wind spring being sleeved on the fixed discs, and a coiling end of the wind spring being clamped with the coiling disc; and an adjusting plunger, one end of the adjusting plunger being in transmission connection with the coiling disc, and the other end of the adjusting plunger being connected with the reel through a transmission structure. By mounting a coiling apparatus in the prior art in an upper beam, the widths of a left bracket and a right bracket in the prior art can be greatly reduced, thereby being more suitable for blinds with narrower brackets and small face widths.

### CROSS REFERENCE TO RELATED APPLICATIONS

The present application claims the benefit of Chinese Patent Application Nos. 202123083043.5 filed on Dec. 9, 2021 and 202220582065.1 filed on Mar. 17, 2022, and PCT Application No. PCT/CN2022/113812 filed on Aug. 22, 2022. All the above are hereby incorporated by reference in their entirety.

### TECHNICAL FIELD

The disclosure relates to the technical field of blinds, in particular to a wind spring coiling apparatus with a wind spring built in an upper beam.

### BACKGROUND

An existing spring blind generally includes brackets on both sides and a reel, a spring rod is arranged in the reel, the spring rod is sleeved with a limiting spring, and a spring tail plug is mounted at an end of the limiting spring. The rebound force of the limiting spring is obtained by rotating in advance according to the size and weight of a blind. However, the number of rebound loops of the spring rod with this structure is limited, and the rebound force is not balanced. A longer spring rod is required for more rebound loops and more balanced rebound force, but the longer spring rod cannot be put into a blind with a small face width.

In view of the above technical problems, a hand-held wind spring roller blind (patent No.: CN 210508989U) is proposed, including a left bracket, a right bracket and a hanger connecting the left bracket and the right bracket. A reel is arranged between the left bracket and the right bracket, a roller blind is arranged on the reel, and a wind spring coiling apparatus for rotating the reel and coiling the roller blind is arranged on the left bracket and/or the right bracket. By mounting the coiling apparatus in the left bracket and the right bracket and arranging a wind spring in the coiling apparatus, the presetting of the torsion is realized, and the torsion for reel shrinkage can be adjusted.

However, the above patent has the following problem: since the wind spring is mounted on a side wall of the left bracket and a side wall of the right bracket and the wind spring has a certain width, the left bracket and the right bracket are larger in a width direction. Therefore, when users need bracket products with narrow edges, the above structure cannot meet the needs of users.

### SUMMARY

In view of the defects of the prior art, the disclosure provides a wind spring coiling apparatus with a wind spring built in an upper beam. A left bracket and/or a right bracket in the prior art are set as a combination of a horizontal part and a vertical part, and then, the coiling apparatus is mounted in the horizontal part, so that the width of the vertical part of the left bracket and/or the right bracket is greatly reduced to meet the product requirements of users for brackets with narrow edges.

The disclosure solves the above technical problems through the following technical solutions: disclosed is a wind spring coiling apparatus with a wind spring built in an upper beam, including an upper beam and a bracket, the bracket being provided with a reel for driving a roller blind to roll up and unfold, wherein the bracket includes a horizontal part, the arrangement direction of which is consistent with that of the upper beam, and a vertical part, the arrangement direction of which is perpendicular to that of the upper beam, and further includes a coiling apparatus mounted in the horizontal part, and the coiling apparatus includes:

a wind spring, fixed discs and a coiling disc, the wind spring being sleeved on the fixed discs in a loose state, and a coiling end of the wind spring being clamped with the coiling disc; and

an adjusting plunger, one end of the adjusting plunger being in transmission connection with the coiling disc, the other end of the adjusting plunger being connected with the reel through a transmission structure, and the transmission structure being located in the vertical part.

As a further optimization, the bracket includes a left bracket and a right bracket, and the coiling apparatus is mounted in the horizontal part in the left bracket and/or the horizontal part in the right bracket.

As a further optimization, the adjusting plunger is coaxially connected with the coiling disc.

As a further optimization, the transmission structure adopts gear transmission or belt transmission connection.

As a further optimization, the coiling disc is coaxially connected with a first gear, a second gear and a third gear are mounted in the bracket, the third gear is coaxially connected with the reel, the first gear is engaged with the second gear, and the second gear is engaged with the third gear.

As a further optimization, the coiling disc is coaxially connected with a first take-up reel, a second take-up reel is mounted in the bracket, a fixed pulley is further mounted in the bracket, a belt is connected between the first take-up reel and the second take-up reel, and the direction of the belt is changed through the fixed pulley.

As a further optimization, the adjusting plunger includes a threaded column, a screw head is arranged at one end of the threaded column, the threaded column is in threaded connection with an adjusting nut, and a spring is connected between the adjusting nut and the screw head.

As a further optimization, a cover plate is further mounted on an upper surface of the horizontal part with the coiling apparatus, the cover plate is provided with an adjusting hole, and the screw head is exposed out of the adjusting hole.

The disclosure has the following beneficial effects: 1. A left bracket and/or a right bracket in the prior art are set as a combination of a horizontal part and a vertical part, and then, the coiling apparatus is mounted in the horizontal part, so that the width of the vertical part of the left bracket and/or the right bracket is greatly reduced to meet the product requirements of users for brackets with narrow edges.

2. The adjusting plunger is mounted in the horizontal part, the reel is mounted on the vertical part, the horizontal part and the vertical part are mounted vertically, the transmission between the adjusting plunger and the reel can be realized by means of gear transmission or belt transmission between the adjusting plunger and the reel, the transmission effect is excellent, and thus, the reel can drive the blind to roll up more smoothly.

3. A counterweight is arranged at a lower end of the roller blind. By means of the balanced action between the gravity of the counterweight and the torsion of the wind spring, a user can stop the roller blind at any position to maintain balance when pulling down the roller blind. When the torsion of the wind spring is insufficient or excessive, the torsion of the wind spring can be adjusted by screwing or loosening the screw head to enable the preset torsion to be balanced with the gravity of the counterweight, so that the user can stop the roller blind at any position when pulling down the roller blind.

### BRIEF DESCRIPTION OF FIGURES

In order to more clearly illustrate the technical solutions in the embodiments of the disclosure or in the prior art, the drawings required for description in the embodiments or the prior art are described below. Obviously, the technical solutions described with reference to the drawings are only some embodiments of the disclosure. Those skilled in the art may further obtain other embodiments and drawings thereof according to the embodiments shown in these drawings without any creative work.

FIG. 1 is a schematic structural view of a wind spring coiling apparatus with a wind spring built in an upper beam in the disclosure.

FIG. 2 is a schematic explosive view of an embodiment 1 in the disclosure.

FIG. 3 is a schematic structural view of gear transmission in the embodiment 1 in the disclosure.

FIG. 4 is a schematic structural view of belt transmission in an embodiment 2 in the disclosure.

FIG. 5 is an enlarged view of partial structures in FIG. 2.

In the figures: upper beam 1, bracket 2, horizontal part 201, vertical part 202, left bracket 203, right bracket 204, reel 3, wind spring 4, fixed disc 5, coiling disc 6, adjusting plunger 7, first gear 8, second gear 9, third gear 10, threaded column 11, screw head 12, adjusting nut 13, spring 14, cover plate 15, adjusting hole 16, first take-up reel 17, second take-up reel 18, belt 19, fixed pulley 20, and mounting block 21.

### DETAILED DESCRIPTION

The technical solutions of the embodiments of the disclosure are clearly and completely described below with reference to the drawings. Obviously, the described embodiments are only a part of the embodiments of the disclosure, but are not all of the embodiments. All other embodiments obtained by those skilled in the art on the basis of the embodiments of the disclosure without creative work fall within the protection scope of the disclosure.

An embodiment 1 of the disclosure provides a wind spring coiling apparatus with a wind spring built in an upper beam, including an upper beam 1 and a bracket 2, the bracket 2 being provided with a reel 3 for driving a roller blind to roll up and unfold, wherein the bracket 2 includes a horizontal part 201, the arrangement direction of which is consistent with that of the upper beam 1, and a vertical part 202, the arrangement direction of which is perpendicular to that of the upper beam 1, and further includes a coiling apparatus mounted in the horizontal part 201, and the coiling apparatus includes:

a wind spring 4, fixed discs 5 and a coiling disc 6, the wind spring 4 being sleeved on the fixed discs 5 in a loose state, and a coiling end of the wind spring 4 being clamped with the coiling disc 6; and

an adjusting plunger 7, one end of the adjusting plunger 7 being in transmission connection with the coiling disc 6, the other end of the adjusting plunger 7 being connected with the reel 3 through a transmission structure, and the transmission structure being located in the vertical part 202.

The horizontal part 201 and the vertical part 202 are integrated, that is, a cross section of the bracket 2 is L-shaped and is mounted at both ends of the upper beam 1.

The fixed discs 5 are configured to mount the wind spring 4, and a coiling end of the wind spring 4 is clamped with the coiling disc 6. The wind spring 4 in the fixed discs 5 is coiled to the coiling disc 6, or the coiling end of the wind spring 4 in the coiling disc 6 is coiled back into the fixed discs 5 to achieve the purpose of tightening or loosening the wind spring 4, so as to realize the presetting of different torsions, and the preset torsion of the wind spring 4 is balanced with the gravity of the counterweight to ensure that a user can stop the roller blind at any position when pulling down the roller blind.

The bracket 2 includes a left bracket 203 and a right bracket 204, and the coiling apparatus is mounted in the horizontal part 201 in the left bracket 203 and/or the horizontal part 201 in the right bracket 204.

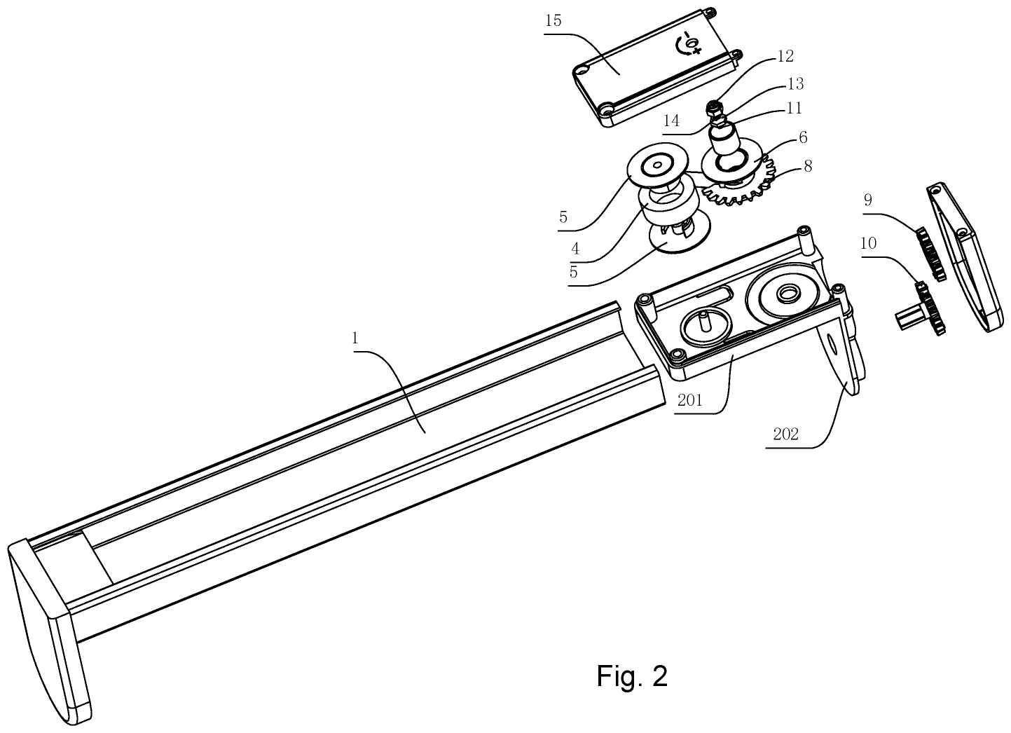

The coiling apparatus may be arranged in the left bracket 203 or the right bracket 204, or may be arranged in both the left bracket 203 and the right bracket 204 in order to increase the torsion of the wind spring 4. Preferably, as shown in FIG. 2, the coiling apparatus is assembled in the right bracket 204.

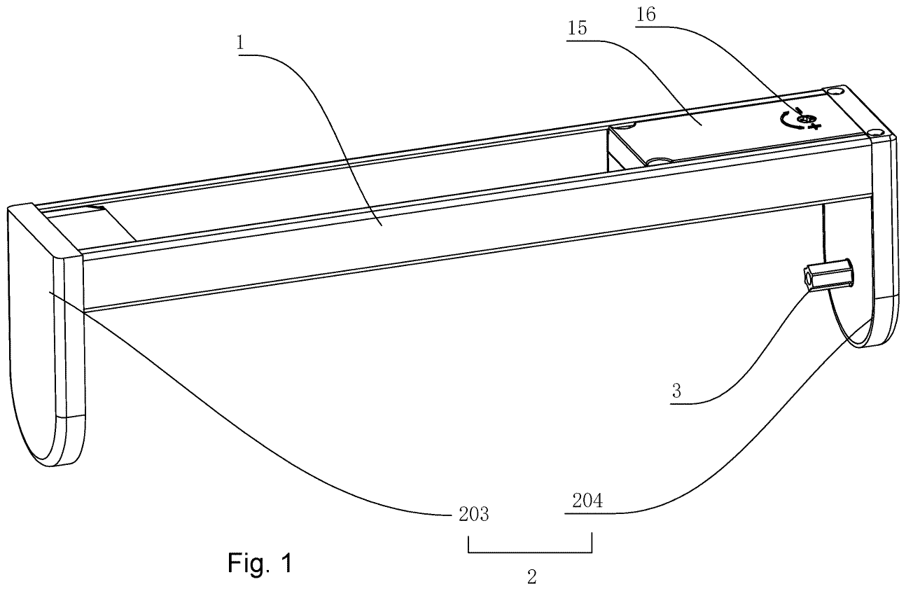

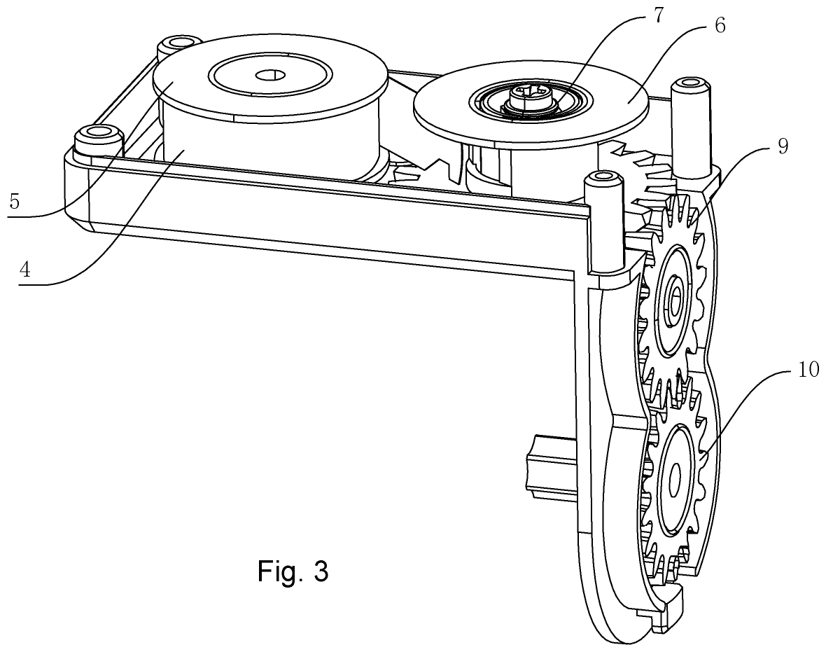

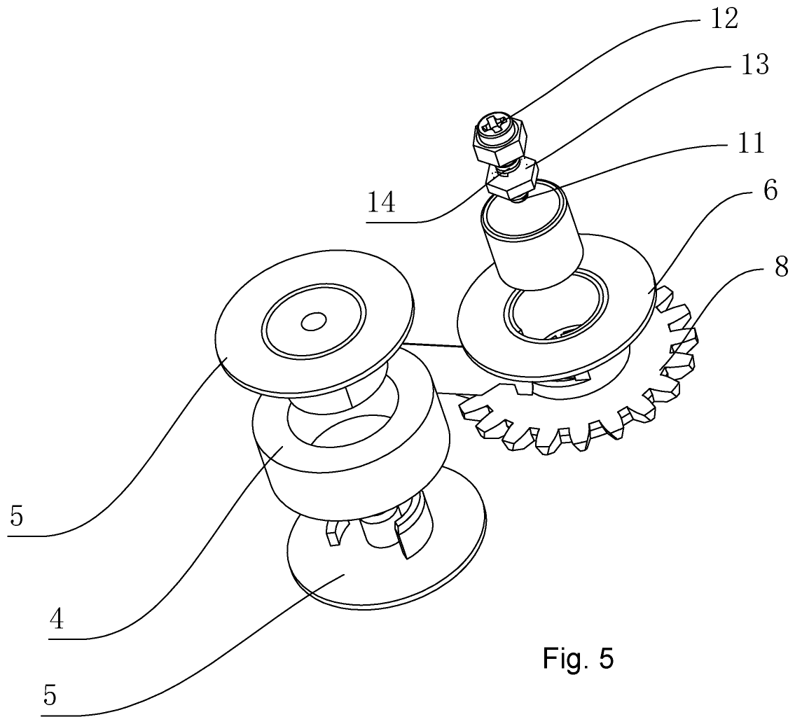

As shown in FIG. 1 to FIG. 3 and FIG. 5, the adjusting plunger 7 is coaxially connected with the coiling disc 6. A preferred connection mode between the adjusting plunger 7 and the coiling disc 6 is coaxial connection. By operating the adjusting plunger 7, the coiling disc 6 can be driven to coil the wind spring 4, and thus, the torsion of the wind spring 4 can be adjusted.

An accommodating cavity for mounting the adjusting plunger 7 is formed in the coiling disc 6, and a through shaft hole is formed in the bottom of the coiling disc 6. By means of the arrangement of the through shaft hole, the adjusting plunger 7 can be mounted in the accommodating cavity in the coiling disc 6 conveniently, and the adjusting plunger 7 is located inside the coiling disc 6 and is coaxially connected with the coiling disc 6.

As shown in FIG. 1 to FIG. 3 and FIG. 5, the transmission structure adopts gear transmission. The coiling disc 6 is coaxially connected with a first gear 8, a second gear 9 and a third gear 10 are mounted in the bracket 2, the third gear 10 is coaxially connected with the reel 3, the first gear 8 is engaged with the second gear 9, and the second gear 9 is engaged with the third gear 10.

The gear transmission is high in efficiency and compact in structure, can be adapted to short distance transmission between the bracket 2 and the upper beam 1, and has an accurate transmission ratio.

As shown in FIG. 1 to FIG. 3, the adjusting plunger 7 includes a threaded column 11, a screw head 12 is arranged at one end of the threaded column 11, the threaded column 11 is in threaded connection with an adjusting nut 13, and a spring 14 is connected between the adjusting nut 13 and the screw head 12. The torsion of the wind spring 4 can be adjusted through the structure of the threaded column 11 and the adjusting nut 13.

When in use, as the counterweight is arranged at the lower end of the roller blind (the structure has been formed in the prior art and thus is not shown in the figures), the user pulls down the roller blind and drives the reel 3 to rotate at the same time, so as to drive the wind spring 4 to accumulate the torsion by means of the transmission of the transmission structure. When the user stops pulling the roller blind, the torsion of the wind spring 4 is balanced with the gravity of the counterweight, so that the roller blind can be stopped at any position. When the torsion of the wind spring 4 is insufficient or excessive, the preset torsion of the wind spring 4 can be adjusted by operating the adjusting plunger 7 to enable the torsion of the wind spring 4 to be balanced with the gravity of the counterweight, so that the roller blind can be stopped at any position.

As shown in FIG. 1 to FIG. 3 and FIG. 5, a cover plate 15 is further mounted on an upper surface of the horizontal part 201 with the coiling apparatus, the cover plate 15 is provided with an adjusting hole 16, and the screw head 12 is exposed out of the adjusting hole 16.

By means of the adjusting hole 16, the screw head 12 is exposed, and thus, the user can adjust the preset torsion of the wind spring 4 by operating the screw head 12. In order to more obviously prompt the user to adjust the torsion of the wind spring 4 in a torsion adjusting direction, a prompt pattern of the torsion adjusting direction can be set on the cover plate 15 to prompt the user.

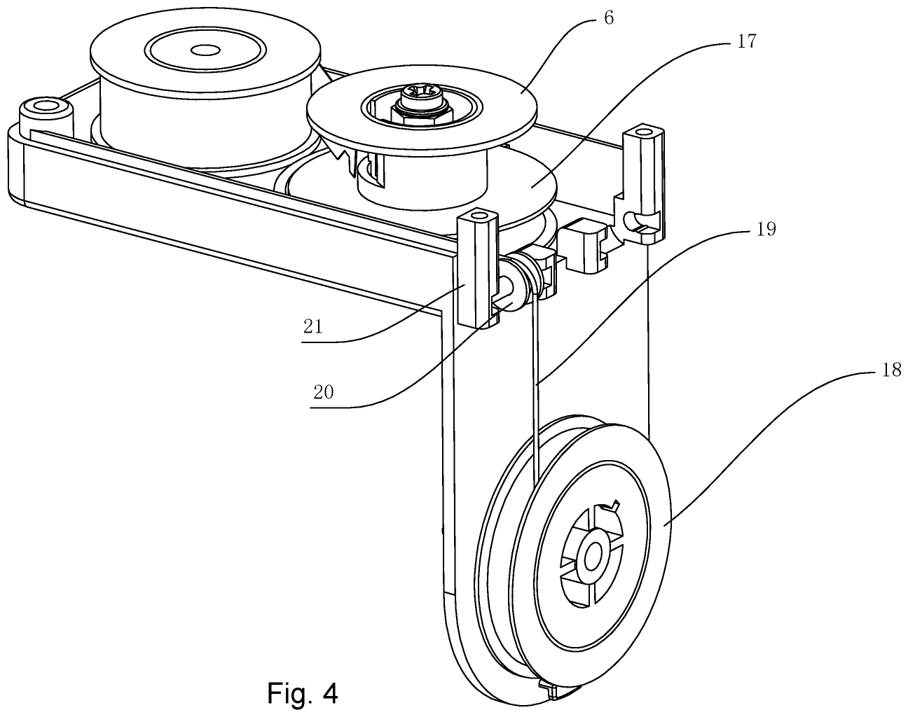

An embodiment 2 of the disclosure provides a wind spring coiling apparatus with a wind spring built in an upper beam. As shown in FIG. 4, compared with embodiment 1, the differences are as follows:

The transmission structure adopts belt transmission.

The coiling disc 6 is coaxially connected with a first take-up reel 17, a second take-up reel 18 is mounted in the bracket 2, a fixed pulley 20 is further mounted in the bracket 2, a belt 19 is connected between the first take-up reel 17 and the second take-up reel 18, and the direction of the belt 19 is changed through the fixed pulley 20.

In order to facilitate the mounting of the fixed pulley 20, a mounting block 21 is fixedly connected in the bracket 2. The fixed pulley 20 is mounted on the mounting block 21 to realize the stable transmission of the fixed pulley 20 to the belt 19.

The transmission mode of the belt 19 is relatively stable, noiseless and lower in cost.

The specific application of the disclosure is as follows: as the counterweight is arranged at the lower end of the roller blind (the structure has been formed in the prior art and thus is not shown in the figures), the user pulls down the roller blind and drives the reel 3 to rotate at the same time, so as to drive the wind spring 4 to accumulate the torsion by means of the transmission of the transmission structure. When the user stops pulling the roller blind, the torsion of the wind spring 4 is balanced with the gravity of the counterweight, so that the roller blind can be stopped at any position. When the torsion of the wind spring 4 is insufficient or excessive, the preset torsion of the wind spring 4 can be adjusted by operating the adjusting plunger 7 to enable the torsion of the wind spring 4 to be balanced with the gravity of the counterweight, so that the roller blind can be stopped at any position.

It is obvious to those skilled in the art that the disclosure is not limited to the details of the above exemplary embodiments, and that the disclosure can be implemented in other specific forms without departing from the spirit or basic features of the disclosure. Therefore, from any point of view, the embodiments should be regarded as exemplary and non-restrictive. The scope of the disclosure is defined by the appended claims rather than the above description, so it is intended to include all changes within the meaning and scope of the equivalent elements of the claims in the disclosure. Any reference numeral in the claims should not be regarded as limiting the claims involved.

In addition, it should be understood that although this description is described according to the implementations, not every implementation only includes an independent technical solution. The narrative of the description is only for the sake of clarity, and those skilled in the art should take the description as a whole. The technical solutions in each embodiment may also be appropriately combined to form other implementations that can be understood by those skilled in the art.

What is claimed is:

1. A wind spring coiling apparatus with a wind spring built in an upper beam, comprising an upper beam (1) and a bracket (2), the bracket (2) being provided with a reel (3) for driving a roller blind to roll up and unfold, wherein the bracket (2) comprises a horizontal part (201), the arrangement direction of which is consistent with that of the upper beam (1), and a vertical part (202), the arrangement direction of which is perpendicular to that of the upper beam (1), and further comprises a coiling apparatus mounted in the horizontal part (201), and the coiling apparatus comprises:
a wind spring (4), fixed discs (5) and a coiling disc (6), the wind spring (4) being sleeved on the fixed discs (5) in a loose state, and a coiling end of the wind spring (4) being clamped with the coiling disc (6); and
an adjusting plunger (7), one end of the adjusting plunger (7) being in transmission connection with the coiling disc (6), the other end of the adjusting plunger (7) being connected with the reel (3) through a transmission structure, and the transmission structure being located in the vertical part (202).

2. The wind spring coiling apparatus with a wind spring built in an upper beam according to claim 1, wherein the bracket (2) comprises a left bracket (203) and a right bracket (204), and the coiling apparatus is mounted in the horizontal part (201) in the left bracket (203) and/or the horizontal part (201) in the right bracket (204).

3. The wind spring coiling apparatus with a wind spring built in an upper beam according to claim 1, wherein the adjusting plunger (7) is coaxially connected with the coiling disc (6).

4. The wind spring coiling apparatus with a wind spring built in an upper beam according to claim 1, wherein the transmission structure adopts gear transmission or belt transmission connection.

5. The wind spring coiling apparatus with a wind spring built in an upper beam according to claim 4, wherein the coiling disc (6) is coaxially connected with a first gear (8), a second gear (9) and a third gear (10) are mounted in the bracket (2), the third gear (10) is coaxially connected with the reel (3), the first gear (8) is engaged with the second gear (9), and the second gear (9) is engaged with the third gear (10).

6. The wind spring coiling apparatus with a wind spring built in an upper beam according to claim 4, wherein the coiling disc (6) is coaxially connected with a first take-up reel (17), a second take-up reel (18) is mounted in the bracket (2), a fixed pulley (20) is further mounted in the bracket (2), a belt (19) is connected between the first take-up reel (17) and the second take-up reel (18), and the direction of the belt (19) is changed through the fixed pulley (20).

7. The wind spring coiling apparatus with a wind spring built in an upper beam according to claim 1, wherein the adjusting plunger (7) comprises a threaded column (11), a screw head (12) is arranged at one end of the threaded column (11), the threaded column (11) is in threaded connection with an adjusting nut (13), and a spring (14) is connected between the adjusting nut (13) and the screw head (12).

8. The wind spring coiling apparatus with a wind spring built in an upper beam according to claim 2, wherein a cover plate (15) is further mounted on an upper surface of the horizontal part (201) with the coiling apparatus, the cover plate (15) is provided with an adjusting hole (16), and the screw head (12) is exposed out of the adjusting hole (16).
